(19) United States
(12) Patent Application Publication
(10) Pub. No.: US 2023/0003377 A1
(43) Pub. Date: Jan. 5, 2023

(54) Steam Generator and Control Device

(71) Applicant: STEAMOLOGY MOTION LTD, West Dean (GB)

(72) Inventors: Jeremy Henry Arthur Bliss, Exeter (GB); Christopher Alec Lack, Fordingbridge (GB)

(21) Appl. No.: 17/782,353

(22) PCT Filed: Dec. 4, 2020
(86) PCT No.: PCT/GB2020/000106

§ 371 Date: Jun. 3, 2022

(30) Foreign Application Priority Data
Dec. 4, 2019 (GB) 1917682.5
Dec. 2, 2020 (GB) 2019007.0

(51) Int. Cl. F22B 1/00; F01D 15/10; F01K 25/00; F22B 1/18; F22B 1/26; H02K 7/18

(52) U.S. Cl. CPC F22B 1/003; F01D 15/10; F01K 25/005; F22B 1/1853; F22B 1/26; H02K 7/1823; F05D 2220/76

(57) ABSTRACT

A steam generator comprises: a pressure vessel; a gas inlet to the pressure vessel, arranged to receive hydrogen and oxygen under pressure; an ignition means within the pressure vessel, arranged to ignite hydrogen and oxygen received at the gas inlet; a water jacket in or on the pressure vessel; a water inlet arranged to receive water under pressure and feed it to the water jacket; a spray outlet within the pressure vessel; and a steam outlet for the outlet of steam from the pressure vessel. In use, water received at the water inlet passes along the water jacket to provide cooling of the pressure vessel and is output at the spray outlet to provide a water spray (and/or film) that mixes with the ignited hydrogen and oxygen to vaporize the water spray.

### CROSS-REFERENCE TO RELATED APPLICATIONS

This is the U.S. National Stage application of International Application No. PCT/GB2020/000106, filed Dec. 4, 2020, which claims the benefit of priority from GB Application No. 1917682.5, filed Dec. 4, 2019, and GB Application No. 2019007.0, filed Dec. 2, 2020. The entire contents of these prior applications are incorporated by reference herein.

### FIELD

This relates generally to the field of steam generators, and in particular steam generators that mix hydrogen and oxygen with a water supply to generate a consistent supply of steam. This also relates generally to the field of control devices for steam generators.

### BACKGROUND

There is a constant drive towards conserving energy, and finding sources of energy supply that are renewable. Fossil fuels are being gradually phased out before they run out, and in a bid to reduce carbon emissions, but global energy demands are on the increase. Energy is required for electricity generation, the heating and cooling of air and water, transportation, and other energy services within industry and various manufacturing plants. The solution is to explore renewable energy resources, which are naturally replenished and therefore sustainable. These resources typically make use of wind, sunlight, tides, waves and geothermal heat. But whilst these resources offer a plentiful supply, it can be intermittent, and their capacity is not always adequate when energy requirement is high. The energy supply that they provide does not always match demand. There are also numerous issues with existing renewable energy solutions.

In the supply of electricity, harnessing the power of the wind through wind turbines has proven successful to meet demand, although the efficiency of these wind turbines is low and their locations limited by geography. Hydroelectric generators present a similar geographical issue, and the scale of such power generation plants considerable. The usable electricity generated as a product of these renewable generators cannot be stored, and therefore an additional device is required to do this.

Proposals that make use of fuel cells or rechargeable batteries, whilst not as such renewable, do offer an alternative energy source. Lithium is a common metal used for such batteries, and although the supply of this metal is finite and will eventually run out, it does provide a very recyclable resource. The situation is similar for other chemical batteries, where energy storage and global deployment presents a challenge. However, these battery systems do require toxic chemicals, and considerable energy expenditure to produce. End-of-life disposal also presents issues due to the toxic nature of the materials, and the fact that metals such as lithium are highly reactive elements. The costs are high and the supply chain unsustainable.

A further energy resource that is becoming more widely used is fuel cells, and often hydrogen fuel cells. These fuel cells can provide electricity continuously, for as long as a source of fuel and oxygen is supplied. However, production of these fuel cells typically requires considerable energy, and the processing costs can be extremely high. Although they provide clean technology, these fuel cells present numerous issues from cradle to grave. Hydrogen fuel cells in particular require extremely high purity hydrogen to operate, which presents manufacturing and storage issues. These fuel cells also suffer from delayed start up times and are susceptible to changes in environmental conditions, movements and are prone to delivering a variable voltage. They also require temperature management, such as through the addition of a cooling system.

Climate change and global warming concerns are driving research into the use of renewable energy resources. But in order to find a truly renewable, sustainable and consistent solution, the disadvantages of existing renewable energy sources must be addressed. There is a need for a sustainable energy generator, with zero emissions, and no performance losses with each charging cycle, and no degradation over time. There is a need to make use of readily available, non-specialist, materials, and to deploy standard manufacturing processes. Energy expenditure at the start of the life cycle of the product must be addressed. There is a need to minimise the number of moving parts where possible, and to therefore reduce the risk of failure. There is a need to use component parts that can be readily serviced. There is a need to provide a plentiful, renewable energy supply and deliver energy generators that are low noise, and not as such geographically limiting. Sustainable energy generators are currently being developed to address these needs. The aim being for these generators to be zero emission generators, that maximise cycle efficiency, and resist degradation over time. These sustainable energy generators, such as steam generators, make use of readily available, non-specialist materials, and many deploy standard manufacturing processes. There is a need to provide a plentiful, renewable energy supply and deliver energy generators that are low noise, and not as such geographically limiting.

With these sustainable energy generators, control is key. There is a need for an effective control system for controlling energy generators, such as steam generators, to ensure that energy supply needs are met, whilst monitoring and preventing failure of the generator. There is a need for any control system to eliminate the risks associated with energy generators, such as fire or explosions. Driving a conventional turbine with a steam generator has historically been regarded as inefficient, and dismissed as an impractical approach. Typically, the heat of combustion of the reaction has been seen as an undesirable by-product that must somehow be dissipated to prevent damage and generator failure. The system as a whole must be finely tuned to prevent considerable energy losses, such as the amount of energy lost to dissipate excessive heat, which typically results in unacceptably low efficiencies. There is a need to control and regulate pressure, temperature and gas flow within any steam generator system and for the system to directly respond to any abnormal conditions reported within the system.

The prior art shows a number of devices which attempt to address these needs in various ways.

EP 2 912 374 (Thyssenkrupp Marine Systems GMBH) discloses an apparatus and method for generating water vapour through the combustion of hydrogen and oxygen in a combustion chamber, whilst adding water. This document aims to address the issues of existing steam generators where internal temperatures reach extreme levels, such that specialist components and materials are required, and the outer walls of the chamber become too hot to be practical in a wide variety of environments. The adiabatic flame temperature can be comparatively high during the stoichiometric combustion of hydrogen and oxygen, so that the water vapour becomes dissociated into hydrogen and oxygen. The resulting steam requires a catalytic post-combustion process to purify and remove the dissociated hydrogen and oxygen. The solution is to provide at least one cooling water passage on the outer wall of the combustion chamber. Liquid water is also introduced together with the oxygen supply in the combustion zone of the chamber, rather than, or in addition to, the post-combustion zone. This lowers the reaction temperature, preventing dissociation of water vapour, and generating steam of the highest purity. However, addition of water alongside the oxygen supply reduces the temperature of the steam prior to igniting and mixing the hydrogen and oxygen, and therefore reduces the efficiency of the process. The cooling water passage provides some cooling of the external walls of the combustion chamber, but only where these have been placed.

U.S. Pat. No. 9,617,840 (World Energy Systems Inc) discloses a steam generation system for recovering oil, proposing a water-cooled liner for a combustion sleeve. The liner may incorporate a fluid injection strut to inject atomized droplets of the fluid into the combustion chamber, to generate a heated vapour. However, the steam generation system is for use as a downhole steam generator, and not as a renewable source of energy.

U.S. Pat. No. 5,644,911 (Westinghouse Electric Corp) discloses a steam turbine power system and method of operation that injects and combusts hydrogen and oxygen in a stoichiometric ratio. This semi-closed steam turbine produces little by-product other than water, alongside superheated steam. A portion of the high-pressure steam generated by the steam compressor may be received by, and used to cool, the steam turbine.

U.S. Pat. No. 2,010,314 878 (Dewitt) discloses a hydrogen and oxygen combustion system for generating steam, that incorporates means to regulate and control temperature and pressure conditions within the system. Steam is generated directly by the combustion reaction between hydrogen and oxygen, temperature-is regulated by the injection of water into the body of super-heated steam generated by such a reaction. System temperature is regulated. System pressure is regulated by controlling the total flow of hydrogen, oxygen and water into the combustion chamber of the steam-generating engine. The data is transmitted to a central control system, with temperature data being obtained through a thermocouple sensor array and pressure data being transmitted from a pressure-transducer sensor array. These sensor arrays are located in the immediate proximity of the steam intake port of the turbine, or alternative application device, and are therefore connected in flow communication with the steam-generating engine. The computerized central control system regulates individual hydrogen and oxygen gas flow-rates, water injectate flow-rate, and overall system efficiency of one or a plurality of steam-generating engine systems, producing optimally-conditioned steam driven devices.

U.S. Pat. No. 4,074,708 (Combustion Eng) discloses an apparatus for rapidly superheating steam flowing to a turbine, so that the unit can be quickly put back into operation after a short shutdown such as a hot restart. The apparatus includes a steam generator that burns hydrogen and oxygen directly in the steam lines to the turbine. During operation, hydrogen and oxygen are supplied to a super heater which includes a burner, through supply lines from storage tanks. During normal operation of the generator, a small amount of power can be rectified to operate an electrolyser, generating the hydrogen and oxygen necessary for firing the superheater, such as during a hot restart. Control valves in the feed lines feed the proper amount of hydrogen and oxygen to the burner in the superheater in order to maintain the temperature at the exit point. The valves are controlled by a controller which receives a temperature signal from a temperature sensing device. Flow meters are used to measure the amount of hydrogen and oxygen flowing to the burners, and these signals are fed to the controller to position the valves so as to maintain a stoichiometric ratio. Whilst this apparatus proposes a control system that talks to various sensors, the disclosed apparatus does not generate steam. Rather, steam is made elsewhere and simply boosted in temperature by a hydrogen-oxygen burner to super heat. There is no control of the generation of steam at source.

### BRIEF SUMMARY

Whilst prior art proposals appear to address the issue of efficiency of existing steam generators, and temperature regulation of the combustion chamber, they do not address the issue of efficiently capturing the combustion heat, and making use of this heat. Controlling and containing combustion heat allows for standard materials to be used, through standard manufacturing methods. They also do not address the issue of requiring a high purity of supply gas, and in particular purity of the hydrogen supply. Requiring high purity involves either pre combustion or post combustion processes. Whilst prior art proposals appear to also address the issue of system efficiency, and control of temperature and pressure within the system to prevent failure and eventual shutdown, they do not offer means to finely tune the system to maximise energy output, whilst regulating pressure conditions to prevent fire and/explosions.

Preferred embodiments of the present invention aim to provide a steam generator constructed from standard materials and through common manufacturing processes, enabled through efficient temperature regulation and heat transfer. They also aim to provide a constant supply of energy from a renewable source, that is not reliant on special treatments and circumstances of said source. They also aim to provide a steam generating module that can be constructed in a range of sizes according to use, and that is not limited by geography or specific environmental conditions. Preferred embodiments of the present invention aim to provide a steam generation system with control to monitor and regulate temperature and therefore heat transfer, to vastly improve system efficiency, whilst also monitoring pressure to eliminate risk of generator failure.

According to one aspect of the present invention, there is provided a steam generator comprising:
a pressure vessel;
a gas inlet to the pressure vessel, arranged to receive hydrogen and oxygen under pressure;
an ignition means within the pressure vessel, arranged to ignite hydrogen and oxygen received at the gas inlet;
a steam outlet for the outlet of steam from the pressure vessel;
a water jacket in or on the pressure vessel;
a water inlet arranged to receive water under pressure and feed it to said water jacket;
and,
a water outlet positioned within the pressure vessel between the gas inlet and the steam outlet, wherein, in use: water received at the water inlet passes along said water jacket to provide cooling of the pressure vessel and is output at said water outlet to provide a water spray and/or film that mixes with the ignited hydrogen and oxygen to vaporize the water spray and/or film, the water outlet comprising a body around which gas flows, when flowing from the gas inlet to the steam outlet.

Preferably, the pressure vessel comprises a double-walled construction, forming the water jacket therebetween.

Preferably, the pressure vessel comprises a combustion zone within which the ignition means is mounted, the combustion zone being configured to receive hydrogen and oxygen from the gas inlet, and to mix said gases together during the combustion process.

Preferably, the pressure vessel comprises a water spray zone within which the water outlet is mounted.

Preferably, the water outlet is arranged at a tip of a bullet-shaped portion, the bullet-shaped portion being mounted concentrically within the pressure vessel, along a central axis of the pressure vessel, with the tip facing the combustion zone.

Preferably, the water outlet comprises a nozzle.

Preferably, the water outlet comprises a plurality of channels for creating an array of water.

Preferably, the array is a radial fan, extending generally radially of a principal axis of the pressure vessel.

Preferably, the water outlet comprises molybdenum.

Preferably, the ignition means comprises a glow plug.

Preferably, the steam outlet is at an opposite end of the pressure vessel to the gas inlet.

Preferably, the steam outlet incorporates a valve control means.

Preferably, the valve control means is a De Laval nozzle.

The gas inlet may comprise a gas mixing nozzle for mixing gases as they pass therethrough.

Preferably, the gas mixing nozzle comprises a plurality of longitudinal grooves for mixing the gases.

The gas inlet may comprise two separate paths, one for hydrogen and one for oxygen, so arranged that the hydrogen and oxygen mix within the pressure vessel as they are output from the gas inlet.

Preferably, the pressure vessel is substantially cylindrical.

Preferably, the pressure vessel incorporates a mixing zone that provides a space within which gases in the vessel are mixed, in use.

Preferably, the water outlet is positioned between the combustion zone and the mixing zone.

According to a further aspect of the present invention, there is provided a steam generation system comprising a steam generator, a gas supply system for the generator, a water supply system for the generator, and a controller for the steam generation system, wherein:

the steam generator comprises:
inputs for hydrogen gas, oxygen gas, a purge gas and water;
an igniter arranged to ignite hydrogen and oxygen within the generator; and
an output for pressurised steam generated by the ignition of hydrogen and oxygen within the generator:
   the gas supply system comprises a first, high-pressure stage and a second, low-pressure stage, in which:
the first, high-pressure stage is arranged to receive hydrogen, oxygen and purge gas under pressure and to supply those gases to the second, low-pressure stage under reduced pressure;
the second, low-pressure stage is arranged to receive the gases from the first, high-pressure stage under reduced pressure and to supply those gases to the steam generator:
   the water supply system is arranged to supply water under pressure to the steam generator: and
   the controller is arranged to control operation of the steam generation system in Prime, Run and Shutdown phases, in which:
in the Prime phase, hydrogen gas and oxygen gas are introduced into the first, high-pressure stage and pressure of the hydrogen and oxygen is allowed to build up in the first, high-pressure stage;
in the Run phase, hydrogen gas and oxygen gas are introduced into the second, low-pressure stage at a lower pressure than that prevailing in the first, high-pressure stage; the hydrogen and oxygen gases are then supplied into the steam generator where they are ignited by the igniter; and water is supplied into the steam generator to be mixed with the ignited gases; and
in the Shutdown phase, the supply of hydrogen and oxygen gases to the steam generator is ceased, the supply of water to the steam generator is ceased, and a purge gas is supplied to the gas supply system and the steam generator to purge the gas supply system and the steam generator of hydrogen and oxygen gases.

In the context of this specification, for ease of reference, the terms ‘high-pressure’ and ‘low-pressure’ are used to denote pressures that are high and low relative to one another, as may obtain in the first and second stages of the gas supply system.

Preferably, in the Prime phase, respective low-flow valves are initially opened to allow the pressure of the hydrogen and oxygen to build up gradually; and subsequently, respective high-flow valves are opened to allow the pressure of the hydrogen and oxygen to build up more quickly.

Preferably, in the Run phase, the controller calculates, from measurements of temperature, pressure and mass flow of hydrogen and oxygen, a stoichiometric mass ratio of oxygen to hydrogen; and controls valves in the system to maintain said stoichiometric mass ratio at a desired level.

Preferably, in the Run phase, the controller monitors water mass flow and either hydrogen or oxygen mass flow; and adjusts those mass flows to achieve a desired overall mass flow through the steam generator.

Preferably, operation of the steam generation system is controlled by user actuation of a Start Button and a Shutdown Button.

Preferably, in use, the Prime phase is started by a first actuation of the Start Button.

Preferably, in use, the Run phase is started by actuation of the Start Button after completion of the Prime phase.

Preferably, in use, the steam generation system enters a Standby condition upon actuation of the Start Button during the Run phase.

Preferably, a steam generation system according to any of the preceding aspects of the invention comprises at least one indicator to indicate at least one of successful completion of the Prime phase; successful activation of the Run phase; and a Fault condition.

Preferably, the controller is operative to detect fault conditions comprising one or more of the following at or within a predetermined time:
pressure within the system falling outside a predetermined limit;
flow rate within the system falling outside a predetermined limit;
temperature within the system falling outside a predetermined limit; and
electrical ignition current supplied to the steam generator falling outside a predetermined limit.

Preferably, the controller is operative to initiate the Shutdown phase upon a fault condition being detected.

A steam generation system according to any of the preceding aspects of the invention may incorporate at least one steam generator according to any of the preceding aspects of the invention.

The invention extends to a turbine generator incorporating at least one steam generator or steam generation system according to any of the preceding aspects of the invention.

### BRIEF DESCRIPTION OF THE DRAWINGS

For a better understanding of the invention and to show how embodiments of the same may be carried into effect, reference will now be made, by way of example, to the accompanying diagrammatic drawings, in which:

FIG. 1 shows one embodiment of steam generator in section view, showing a double walled pressure vessel;

FIG. 2 is a view similar to FIG. 1, but rotated about a principal axis by 90 degrees, showing the flow path of gases through the steam generator and gas mixing zones;

FIG. 3 is a view similar to FIG. 1, showing the flow of water through the steam generator;

FIG. 4 shows one embodiment of a gas inlet;

FIG. 5A shows one embodiment of spray outlet in isometric view;

FIG. 5B shows the spray outlet of FIG. 5A in exploded view;

FIG. 6 shows a pair of steam generators mounted side by side, and operatively connected to a turbine;

FIG. 7 shows a diagrammatic representation of a method of generating steam using the steam generator;

FIG. 8 is a schematic diagram of one embodiment of a steam generation system, showing a first, high-pressure stage of a gas supply system;

FIG. 9 is a schematic diagram showing a second, low-pressure stage and control panel of the gas supply system of FIG. 8, the second, low-pressure stage being connected to the first, high-pressure stage of FIG. 8 at A-A; and

FIG. 10 shows a control panel of a controller of the steam generation system of FIGS. 8 and 9.

In the figures like references denote like or corresponding parts.

### DETAILED DESCRIPTION

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

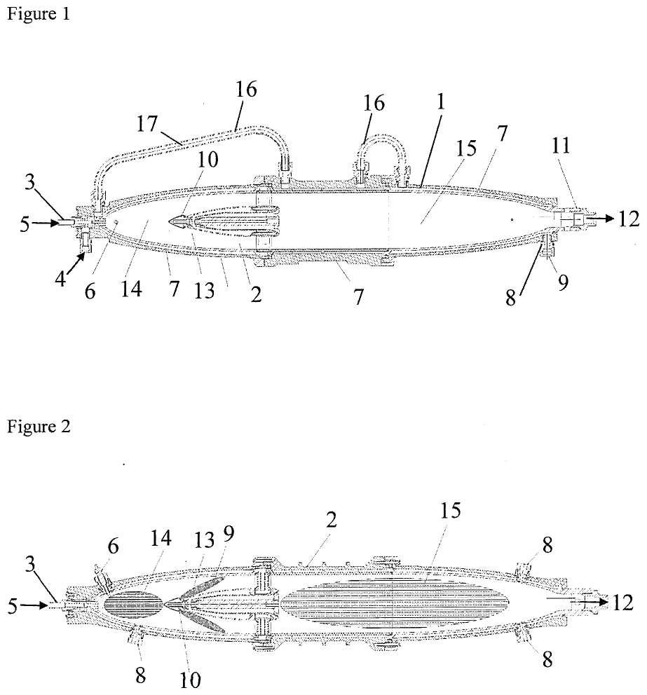

FIGS. 1 to 3 show one embodiment of a steam generator 1 that comprises a generally cylindrical pressure vessel 2. The pressure vessel 2 incorporates at least one gas inlet 3 at one end. The gas inlet 3 supplies hydrogen 4 and oxygen 5 as gaseous fuel into the pressure vessel 2. These gaseous fuels are likely to be of a wide range of purity. These gases are likely to have been pressurised prior to entry to the pressure vessel 2. Therefore, in this example, the pressure vessel 2 is supplied with pressurised hydrogen 4 and pressurised oxygen 5. The pressurised hydrogen 4 and pressurised oxygen 5 enter through one or more gas inlet 3 into a combustion zone 14 and are configured such that upon entry to the pressure vessel 2 they begin to mix. An ignition means 6 is located to generate a flame and ignite the hydrogen 4 and oxygen 5 mixture, generating steam 12. It is generally known that steam 12 is generated by combusting hydrogen 4 and oxygen 5.

The ignition means 6 may comprise a glow plug. Typically, a glow plug is a pencil-shaped piece of metal with a heating element at the tip. This heating element, when supplied with electricity, heats due to its electrical resistance and begins to emit light in the visible spectrum. The filaments that make up the glow plug are preferably made of platinum or iridium, materials that resist oxidation at high temperatures. The ignition means 6 may also comprise alternative heating elements that suit the conditions, such as a spark plug, laser, or other alternative means of ignition.

To generate additional steam 12, water 9 should be introduced into the pressure vessel 2. The water 9 is injected into the pressure vessel 2, via a water jacket 7, through a spray outlet 10 and into a water spray zone 13 which is generally situated post the combustion zone 14. Water may also be sprayed into a mixing zone 15. Water may issue from outlet 10 as a film, as an alternative to or in addition to a spray.

The pressurised hydrogen 4 may be introduced into the pressure vessel 2 in a manner spatially separated from the pressurised oxygen 5. The introduction of water 9 into the pressure vessel 2 results in the adiabatic flame temperature in the pressure vessel 2 being locally lowered. The inner walls of the pressure vessel 2 and the other components that make up the steam generator 1 are subjected to an appreciably lower thermal load due to the injection of water 9.

To reduce the thermal load on the outer walls of the pressure vessel 2 even more, the water jacket 7 surrounds at least the casing of the combustion zone 14 and the casing of the mixing zone 15. This water path through the water jacket 7 cools the pressure vessel 2. Although the water 9 injected into the pressure vessel 2 ensures that the reaction temperatures are likely to be comparatively low, by cooling the outer walls of the pressure vessel 2, the heat energy is retained in the system. The inside of the outer walls can be insulated to further retain heat in the system. The water 9 injected into the pressure vessel 2 is fed from the water jacket 7 that surrounds the casing. This water 9 that surrounds the pressure vessel 2 of the steam generator 1 is directed into the pressure vessel 2 in a common flow as a spray and/or film. Therefore this water spray and/or film has been advantageously preheated.

The water 9 that is added into the water spray zone 13 adjusts the volume and temperature of the resulting steam 12 that is supplied through a steam outlet 11. Therefore, to control the temperature of the steam 12, the volume of the water 9 added to the steam generator 1 during this post combustion phase must also be controlled. It is this water 9 that evaporates (is flashed) due to the temperature of the generated steam 12 residing in the mixing zone 15. The steam 12 is discharged out of the pressure vessel 2 at steam outlet 11. This steam outlet 11 is configured in this embodiment to be at the opposite end of the pressure vessel 2 to the gas inlets 3. The steam outlet 11 may incorporate valve control means. This valve control means may comprise a De Laval nozzle that comprises an hourglass shape, or a tube that is pinched in the middle. This shape accelerates the steam 12 passing therethrough.

FIG. 2 shows the passage of pressurised hydrogen gas 4, pressurised oxygen gas 5, and generated steam 12 through the steam generator 1. The combustion zone 14 shows the gases mixing together during the combustion process. The superheated steam that results from the combustion process is shown in the mixing zone 15, and the resulting steam 12 is shown to pass out through the steam outlet 11. FIG. 2 shows one configuration of gas mixing zones throughout the pressure vessel 2.

As may be seen in the figures, the water outlet 10 comprises a body around which gas flows, when flowing from the gas inlet 3 to the steam outlet 11.

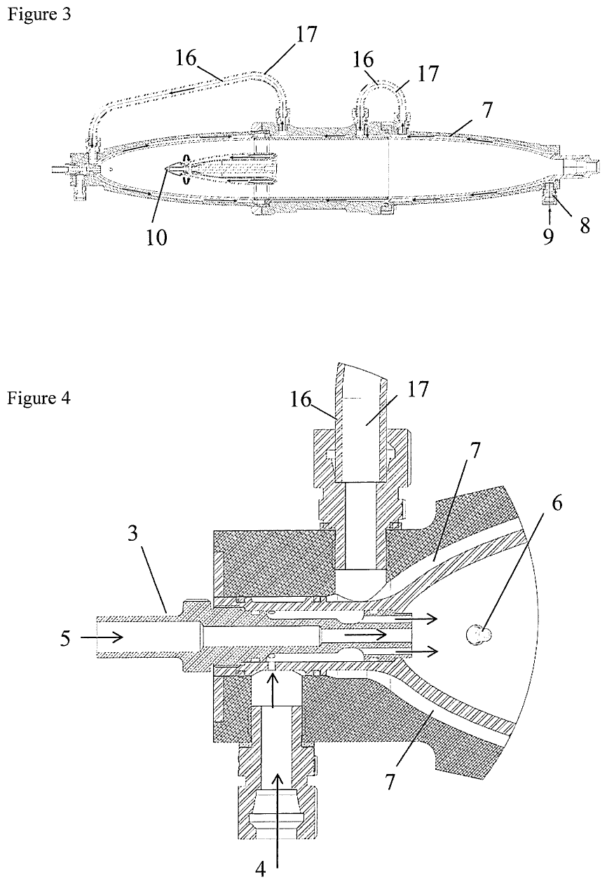

FIG. 3 shows the passage of water 9 through the steam generator 1. The water 9 enters the steam generator 1 through at least one water inlet 8, where it fills the water jacket 7 between the walls of the double-walled pressure vessel 2, thus forming the water jacket 7 that surrounds the pressure vessel 2. This water 9 is heated by the inner walls of the pressure vessel 2, as a result of the combustion process. The preheated water 17 passes along water delivery tubes 16 to feed the water 9 into the spray outlet 10, where it is sprayed into the vicinity of the hydrogen oxygen flame. This water spray is configured in such a way to avoid hitting the ignition means 6. The spray outlet 10 is configured in such a way that the water 9 which is fed to it is atomized. Therefore, the spray outlet 10 is advantageously a nozzle, and the spray outlet 10 is configured at the tip of a bullet shaped portion, whereby the bullet-shaped portion is mounted concentrically within the pressure vessel 2, with nozzle and therefore spray outlet 10 facing the combustion zone 14 of the pressure vessel 2. As mentioned, the water 9 may additionally or alternatively be emitted from the outlet 10 as a film.

The spray outlet 10 may be made from a material that can cope with considerably high temperatures. One example of a suitable material for this spray outlet 10 is molybdenum.

FIG. 4 shows one embodiment of gas inlet 3, where hydrogen 4 enters at one inlet and oxygen 5 enters at another inlet and passes through a central gas nozzle, the diameter of which is stepped down in stages, until the oxygen 5 enters the pressure vessel 2 adjacent the glow plug 6. The hydrogen 4 enters longitudinal holes arranged concentrically around the central gas nozzle and passes through the holes until it enters the pressure vessel 2 adjacent the glow plug 6. Thus, in this example, the hydrogen 4 and oxygen 5 become mixed as they both entered the pressure vessel 2 from the inlet 3, via their respective flow paths, in the manner of a surface mix. The diameters of the central gas nozzle and longitudinal holes determine the velocities of the gases. The glow plug 6 ignites the gases, as described above.

In an alternative configuration, the inlet 3 may be configured as a premix gas mixing nozzle that receives both hydrogen 4 and oxygen 5 and mixes them together as they pass through. Longitudinal grooves within the nozzle provide the mixing of the gases. The diameter of the nozzle determines the velocity of the mixed gases.

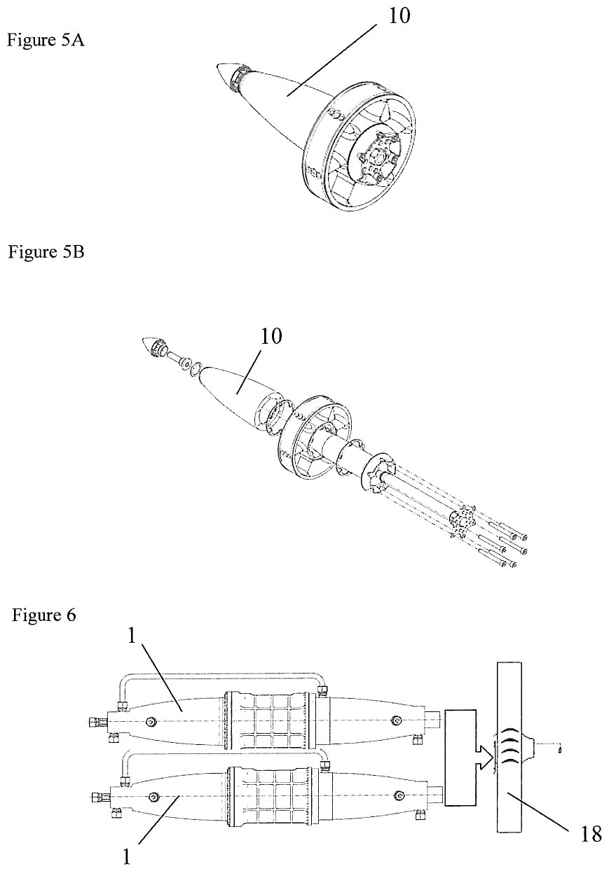

FIGS. 5A and 5B show one embodiment of spray outlet 10 showing multiple channels that redirect the water 9 into a water spray array. One water spray pattern that results may be a radial fan (i.e. extending radially of the general axis of the pressure vessel 2) such that the water spray avoids coming into direct contact with the ignition means 6. This spray outlet 10 is substantially bullet-shaped in configuration and is mounted within brackets so that the spray outlet 10 is along the axis of the pressure vessel 2. This bullet-shaped component creates a divide between the combustion zone 14 at the front of the pressure vessel 2, and the mixing zone 15 at the rear of the pressure vessel 2. The outlet 10 may be configured to output water as a film, in addition to or as an alternative to a spray.

The purpose of the mixing zone 15 is to provide homogenous mixing in the pressure vessel 2. The hydrogen 4 oxygen 5 mixture passing out of the gas inlet 3 is ignited by the ignition means 6, where it is combusted. Combustion of this hydrogen-oxygen mixture forms a hydrogen-oxygen flame, and a product gas results that comprises pure water vapour or steam 12. During the combustion of hydrogen 4 with oxygen 5, the combustion zone 14 is cooled by the water 9 that surrounds the outer walls of the pressure vessel 2. This water 9 is also fed through the spray outlet 10, making up a water spray that is sprayed into the water spray zone 13. This water 9 evaporates forming additional water vapour or steam 12. The steam 12 leaves the steam generator 1 through the steam outlet 11 where it is made available for a wide variety of applications.

FIG. 6 shows a pair of steam generators 1 mounted side by side and configured to discharge steam 12 through their steam outlets 11 to drive a turbine 18. Further configurations might include an arrangement to supply hydraulic power, or mechanical shaft power, or in another arrangement, electricity generation. In FIG. 6, tubes 16 have a different configuration to that shown in FIGS. 1 and 3.

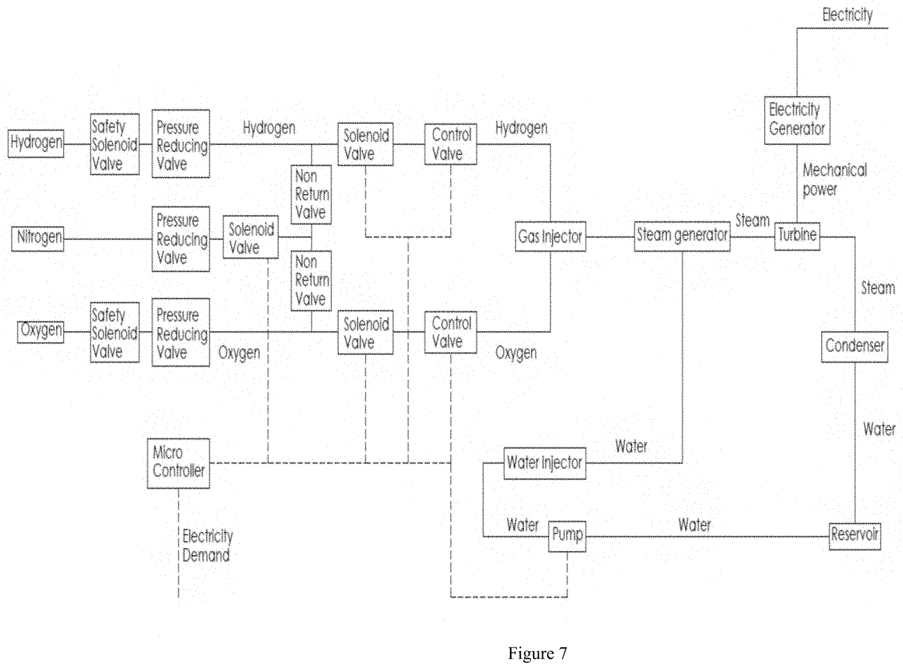

FIG. 7 is a diagrammatic view of a steam generating process using the steam generator 1 and is largely self-explanatory. The steam generator 1 is configured to generate steam 12 from the controlled combustion of pressurised hydrogen 4 and oxygen 5, and the controlled addition of pressurised water 9. The water jacket 7 that surrounds the pressure vessel 1, at least in part, regulates the temperature within the pressure vessel 2. It is this temperature regulation that allows for standard materials to be used, and therefore standard manufacturing techniques. This also ensures that maintenance of the steam generator 1 is non-specialist to a degree. In the example of FIG. 7, generated steam 12 is used to drive a turbine that in turn drives a generator to generate electricity. Nitrogen may be introduced as a purge gas.

The steam generator 1 ensures efficient capture of the combustion heat, and makes use of this heat as part of the process. The combustion of hydrogen 4 and oxygen 5 is at a temperature of around 2,500 degrees Centigrade. This temperature is brought down by the pressurised, preheated water 17, that has been preheated in the water jacket 7, and that is sprayed into the mixing zone 14.

By adding water 9 as a spray to the combusted hydrogen oxygen mixture at 2500° C., the water 9 added as a spray is flashed into superheated steam and in this way the heat energy is converted into mass flow and pressure. The system's effectiveness is enhanced by the subdivision of water 9 into small droplets giving it a large surface area, thus making the flashing-off process more effective. The water 9 is heated by the combusted gases to create more steam 12; the benefit of this is that the combusted gases give up heat to do this and they themselves become useful steam 12 and thus even more steam 12 is generated. This happens from the point the spray is introduced at the spray outlet 10 to the steam outlet 11 of the steam generator 1.

Thus, by adding more water 9 and effectively mixing this water 9 with a pressurised atomised spray of water, the steam mass flow is increased, and the temperature of the bulk steam reduced. An output temperature of 400° C. and an output pressure of 40 bar have been chosen as a preferred example because they provide energy dense steam that can be handled by standard materials.

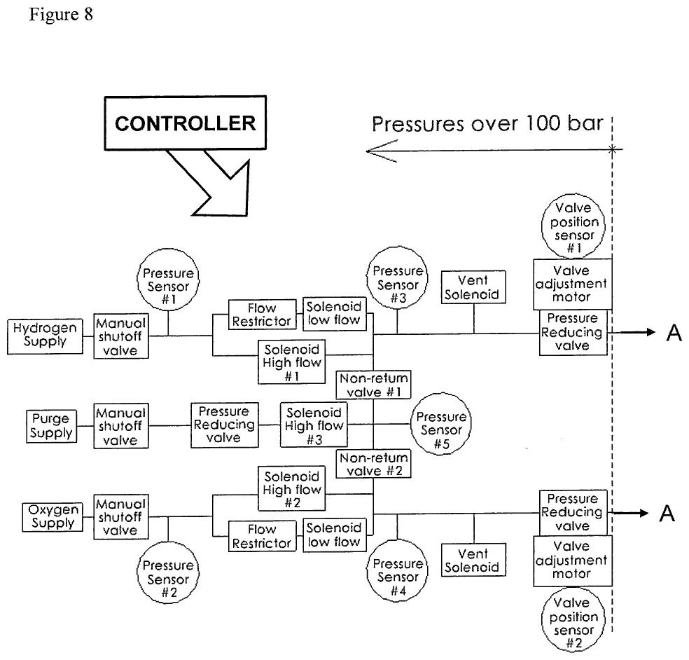

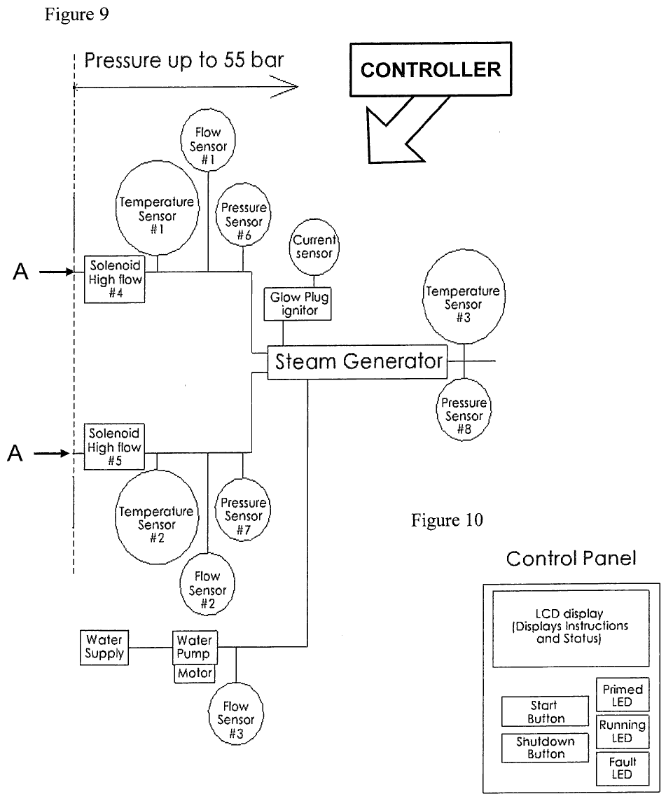

FIGS. 8 and 9 show a steam generation system comprising a steam generator, a gas supply system for the generator, a water supply system for the generator, and a controller for the steam generation system. The steam generator may be, for example, a steam generator as illustrated and described above. The names of the parts of the steam generation system can be seen in FIGS. 8 and 9. A control panel is shown in FIG. 10.

The illustrated system is designed to allow a steam generator to be operated from two buttons—a Start button and a Shutdown button that are provided on the Control Panel. Throttling and standby modes are optionally included in the system, for use at the user's discretion. The buttons may be physical buttons or touch-sensitive elements.

The controller operates in three phases entitled Prime, Run and Shutdown, which will be described below. At start up, a first press of the Start button initiates priming of the system. After this, pressing the Start button will start the system if it is stopped; and stop the system if it is running. The system will remain primed until the Shutdown button is pressed.

As may be seen in FIGS. 8 and 9, the system is divided into two stages, delineated by a vertical broken line and connected through arrows A-A that run from FIG. 8 to FIG. 9. FIG. 8 shows a relatively high-pressure stage, where pressures over 100 bar may prevail. FIG. 9 shows a relatively low-pressure stage, where pressures up to 55 bar may prevail.

FIGS. 8 and 9 show a number of solenoid-operated valves and sensors. For ease of reference, each solenoid-operated valve is referred to in the following as a solenoid. All solenoids are of the normally-closed type with the exception of vent solenoids, which are normally open. Normally-closed means that the solenoid will only open when energised, normally-open means that the solenoid will only close when energised. When the control system is first switched on, all solenoids remain de-energised.

Preferably, the sensors are all or mostly distributed at different, discrete locations of the steam generation system. This allows flexibility of design.

### Prime

When the Start button is pressed at start up, the following sequence of steps is initiated.
1. Pressure sensors #3 to #8 are checked for pressure in the system. If any is above a required pressure level, the system indicates a fault on the LCD display screen of the Control Panel and the system will proceed no further.
2. Pressure sensors #1, #2 and #5 are checked. If any is below a required limit, the system displays a request on the LCD display for manual shutoff valves to be opened and the Start button to be pressed again when the valves are open. If the Start button has been pressed a second time and any of pressure sensors #1, #2 and #5 still registers below the required limit, then the system indicates a fault on the LCD screen and will proceed no further.
3. If the conditions in steps 1 and 2 are met, then the system energises the vent solenoids, thus causing them to close. The system opens both solenoids (low flow) and pipework between the solenoids (low flow) and the pressure reducing valves begins to pressurise. The rate of pressurisation is dictated by flow restrictors upstream of the solenoids (low flow). This affords gradual pressurisation that eliminates the risk of adiabatic heating that may cause failure or fire within the pipework.
4. As the system pressurises, the system monitors pressure sensors #3 and #4 and compares them to pressure sensors #1 and #2 respectively. When the difference between #1 and #2 and #3 and #4 is less than 3 bar, the system closes solenoids (low flow) and open solenoids (high flow) #1 and #2. Throughout this process the system monitors flow sensors #1 and #2. If flow is detected, the process is stopped, solenoids (low flow) and solenoids (high flow) #1 and #2 are closed, the vent solenoids are opened and solenoid (high flow) #3 is opened for 2 seconds; the system indicates a fault on the LCD display and will proceed no further. The purpose of opening solenoid (high flow) valve #3 for 2 seconds is to purge any potentially dangerous gas from the system. The system will then request via the LCD display that the Shutdown button is pressed.
5. If steps 1 to 4 are completed successfully, the priming process is complete; and the ‘Primed LED’ is illuminated and the steam generator is ready to start. At this point, the system can be set to go straight to Start or to go into Standby mode, to await a further press of the Start button to start. If any of pressure sensors #1 to #4 exceeds predetermined limits for high or low pressure, the system will report a fault on the LCD screen and will proceed to Shutdown and the ‘Primed LED’ is extinguished.

### Run

When the Start button is pressed immediately after priming, the Run process begins and the system attempts to achieve target steam temperature, steam pressure and steam mass flow and then maintain these while in Run mode.
1. If at any time the system indicates a fault of any kind, the system will go to Shutdown, this being all solenoid valves closed, vents open and the ‘Primed LED’ extinguished. In this way the system is returned to a safe state.
2. The system checks pressure sensors #3 and #4. If either is outside the starting pressure range, the system indicates a fault on the LCD screen and will then go to Shutdown and the ‘Primed LED’ is extinguished. It then checks valve position sensors #1 and #2 to ensure their respective pressure reducing valves are in the correct position for burner start. This position ensures that initial gas delivery pressures will provide the correct gas mass flows to start a burner of the steam generator. The ratio and magnitude of the gas mass flows for start are variable, dependent on the initial conditions within the steam generator; this varies for hot and cold starts. A cold start is when the generator is initially started and all parts of the generator are at ambient temperature. A hot start is when the generator is re-started a short time after being shut down and parts of the generator will have retained considerable heat.
3. If the conditions in step 2 are met, the system switches on a glow plug ignitor in the steam generator and monitors its current. If the initial current of the glow plug does not reach a required value, the system reports a fault on the LCD screen and will proceed to Shutdown and the ‘Primed LED’ is extinguished.
4. If the conditions in step 3 are met, then the system continues to monitor the glow plug current and as the glow plug heats, the current drops due to increased resistance caused by the heating process. At a given current level, the controller deems the glow plug hot enough to initiate gas ignition.
5. If the conditions in step 4 are met the controller starts the water pump. The controller compares the output from flow sensor #3 to a predetermined flow demand. The difference between these two numbers represents an error between flow demanded and actual flow. If the predetermined flow demand is greater than the flow measured by flow sensor #3, the error is positive and the controller increases the speed of the pump. If the predetermined flow demand is less than the flow measured by flow sensor #3, the error is negative and the controller decreases the speed of the pump. The flow sensor output is measured and the pump speed is adjusted on a loop in software of the system approximately every 1/10 second; this is known as an error loop. If after a predetermined time the output of flow sensor #3 cannot be matched to the predetermined flow demand, the controller indicates a fault on the LCD screen and will proceed to Shutdown and the ‘Primed LED’ is extinguished.
6. When the predetermined flow demand matches the output from flow sensor #3, the controller opens solenoids (high flow) #4 and #5. The gases enter the steam generator and are ignited by the glow plug and thus the production of steam begins. If after a predetermined time temperature sensor #3 does not detect a rise in temperature above a predetermined level, the controller indicates a fault on the LCD screen and will proceed to Shutdown and the ‘Primed LED’ is extinguished. If the temperature does not rise, this indicates the gases have not ignited.
7. In the absence of a fault, the controller then monitors temperature sensor #3 and pressure sensor #8. If the temperature and pressure reach predetermined values within a predetermined time, the steam generator is considered lit and ‘warmed up’. If the predetermined time is exceeded without the predetermined pressure and temperature being achieved, the controller indicates a fault on the LCD screen and will proceed to Shutdown and the ‘Primed LED’ is extinguished.
8. If the conditions in step 7 are met, the system is now in full Run mode and the Running LED will be illuminated. The system will then attempt to achieve target temperature, pressure and mass flow. While doing this, the system must also maintain a stoichiometric mass ratio of 8, of oxygen to hydrogen. Using temperature sensor #1, pressure sensor #6 and flow sensor #1, the controller calculates a hydrogen mass flow. Similarly, using temperature sensor #2, pressure sensor #7 and flow sensor #2, the controller calculates an oxygen mass flow. From these values, the software determines the actual mass ratio of oxygen to hydrogen. The controller then subtracts the actual mass ratio from the stoichiometric ratio, thus determining any error in the ratio. If this error is positive, there is too much oxygen and the oxygen pressure reducing valve is turned down. If the error is negative, the oxygen pressure reducing valve is turned up. This process is continuous during the Run phase, as a gas mixture error loop.
9. Because the oxygen and hydrogen mass flows are linked, the system now needs only to be concerned with two control elements, these being hydrogen mass flow and water mass flow. Target hydrogen mass flow and water mass flow are set either in controller software or by the user. The target water mass flow and hydrogen mass flow can be adjusted to control the overall mass flow and thus can be used to throttle the generator—i.e. to adjust the overall steam mass flow output from the generator. When used for throttling, the overall mass flow and hydrogen mass flow will have been previously mapped and the throttle position will be mapped to a water mass flow and hydrogen mass flow target. Thus, when a throttle change takes place, the new target values are taken from the mapped values. These target mass flows are adjusted by looking at temperature sensor #3 and pressure sensor #8. Error control loops much like the one created for the oxygen mass flow are created for hydrogen mass flow and water mass flow. The errors are formed from the target hydrogen mass flow and the actual hydrogen mass flow and the target water mass flow and actual water mass flow. Whilst the overall mass flow is a target, changes in oxygen mass flow and hydrogen mass flow make only small changes to the overall mass flow. However, when determining whether to change hydrogen mass flow or water mass flow, the current state of the overall mass flow is taken into account. For example, if the temperature is higher than required and the mass flow is lower than required, the water flow is increased; this reduces the temperature but also increases the mass flow. However, if the temperature is higher than required and mass flow is also higher than required, the hydrogen flow is reduced, thus reducing the temperature and decreasing the mass flow.
10. As the system will tend to have a very low frequency response, the direction in which temperature and pressure are moving is also taken into account. For example, if the temperature and pressure are higher than required but falling, then the controller will not change the target values. Equally, if they are higher than required and rising, the magnitude of the response will be increased. All of this leads to a look-up table that determines the system target values for hydrogen mass flow and water mass flow. The table also ensures that only one error loop runs at any time so the controller only runs the error loop for the target value that has been altered; the other error loop is suspended. If the option is to ‘do nothing’ then neither loop is run. In this way the system only corrects itself when necessary. The system will maintain this state until Shutdown is requested. The look up table is as follows:

| Conditions | | Action | |
|---|---|---|---|
| Pressure | Temperature | Low Mflow | High Mflow |
| High Rising | High Rising | Inc Water + | Lower Gas + |
| High Rising | High Falling | Lower Gas | Lower Water |
| High Rising | Low Rising | Lower Water | Lower Water |
| High Rising | Low Falling | Unlikely - possible fault blocked nozzle* | |
| High Falling | High Rising | Lower Gas | Lower Gas |
| High Falling | High Falling | Do nothing | Do nothing |
| High Falling | Low Rising | Do nothing | Do nothing |
| High Falling | Low Falling | Inc Gas | Inc Gas |
| Low Rising | High Rising | Inc Water | Lower Gas |
| Low Rising | High Falling | Do nothing | Do nothing |
| Low Rising | Low Rising | Do nothing | Do nothing |
| Low Rising | Low Falling | Inc Gas | Inc Gas |
| Low falling | High Rising | Unlikely - possible fault steam leak* | |
| Low falling | High Falling | Inc Water | Inc Water |
| Low falling | Low Rising | Inc Water | Inc Gas |
| Low falling | Low Falling | Inc Gas + | Lower Water + |

*In this case, if the situation remains unchanged after a given time (of the order of 5 seconds), the system shuts down and indicates a fault on the LCD display. It should be noted that if system maxima or minima are reached before the given time is reached, the system will shut down anyway and indicate a fault on the LCD display.

11. If the Start button is pressed again, the system ceases steam production by closing solenoids (high flow) #4 and #5, the glow plug is switched off and the Running LED is extinguished.
12. Temperature sensor #3 and pressure sensor #8 are monitored; when the pressure is below 1 bar and the temperature below 100° C., the water pump is switched off.
13. If the Start button is pressed again, the controller restarts the Run process at step 1 of Run.

### Shutdown

Shutdown ensures that all the pipework is depressurised and clear of hydrogen and oxygen, the water pump is switched off, the glow plug ignitor is switched off and the manual valves are closed, thus making the system inert and therefore safe.
1. If the system is producing steam, the system ceases steam production by closing solenoids (high flow) #4 and #5, the glow plug is switched off and the Running LED is extinguished.
2. Temperature sensor #3 and pressure sensor #8 are monitored; when the pressure is below 1 bar and the temperature below 100° C. the water pump is switched off.
3. When the criteria in step 2 have been met, solenoids (high flow) #1 and #2 are closed and the vent solenoids are opened.
4. When pressure sensors #3 and #4 have dropped to less than 1 bar, the vent solenoids are closed and solenoids (high flow) #4 and #5 are opened and solenoid (high flow) #3 is opened for 3 to 5 seconds.
5. When pressure sensors #3, #4, #5, #6 and #7 see pressure below 1 bar, the vent solenoids are opened and solenoids (high flow) #4 and #5 are closed. The system is then considered to be purged and free of pressure downstream of solenoids (high flow) #1 and #2.
6. The controller now requests via the LCD screen that the manual shut off valves be closed and that the Shutdown button be pressed when they are closed.
7. When the criteria in step 6 are met and the Shutdown down button has been pressed as requested, solenoid (high flow) valves #1 and #2 are opened
8. If pressure sensors #1 and #2 are still detecting pressure above 1 bar after 5 seconds, solenoids (high flow) #1 and #2 are closed and the controller reports via the LCD screen that the hydrogen or oxygen manual valves are not properly closed or faulty and need to be checked.
9. If pressure sensor #1 and #2 detect pressure below 1 bar within 5 seconds, solenoid (high flow) #3 is opened to give a final nitrogen purge.
10. If pressure sensor #5 is still detecting pressure above 1 bar after 5 seconds, solenoid (high flow) #3 is closed and the controller reports via the LCD screen that the nitrogen manual valves are not properly closed or faulty and need to be checked.
11. If pressure sensor #5 detects pressure below 1 bar within 5 seconds, solenoid (high flow) valve #3 is closed and the Primed LED is extinguished. The system is now considered fully purged and completely inert.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-33. (canceled)

34. A steam generator comprising:
a pressure vessel;
a gas inlet to the pressure vessel, arranged to receive hydrogen and oxygen under pressure;
an ignition means within the pressure vessel, arranged to ignite hydrogen and oxygen received at the gas inlet;
a steam outlet for the outlet of steam from the pressure vessel;
a water jacket in or on the pressure vessel;
a water inlet arranged to receive water under pressure and feed it to said water jacket; and,
a water outlet positioned within the pressure vessel between the gas inlet and the steam outlet,
wherein, in use: water received at the water inlet passes along said water jacket to provide cooling of the pressure vessel and is output at said water outlet to provide a water spray and/or film that mixes with the ignited hydrogen and oxygen to vaporize the water spray and/or film, the water outlet comprising a body around which gas flows, when flowing from the gas inlet to the steam outlet.

35. The steam generator of claim 34, wherein the pressure vessel comprises a double-walled construction, forming the water jacket therebetween.

36. The steam generator of claim 34, wherein the pressure vessel comprises a combustion zone within which the ignition means is mounted, the combustion zone being configured to receive hydrogen and oxygen from the gas inlet, and to mix said gases together during the combustion process.

37. The steam generator of claim 34, wherein the pressure vessel comprises a water outlet zone within which the water outlet is mounted.

38. The steam generator of claim 34, wherein the water outlet is arranged at a tip of a bullet-shaped portion, the bullet-shaped portion being mounted concentrically within the pressure vessel, along a central axis of the pressure vessel, with the tip facing the combustion zone.

39. The steam generator of claim 34, wherein the water outlet comprises a plurality of channels for creating an array of water.

40. The steam generator of claim 39, wherein the array is a radial fan, extending generally radially of a principal axis of the pressure vessel.

41. The steam generator of claim 34, wherein the water outlet comprises molybdenum.

42. The steam generator of claim 34, wherein the ignition means comprises a glow plug.

43. The steam generator of claim 34, wherein the steam outlet is at an opposite end of the pressure vessel to the gas inlet.

44. The steam generator of claim 34, wherein the steam outlet incorporates a valve control means.

45. The steam generator of claim 44, wherein the valve control means is a De Laval nozzle.

46. The steam generator of claim 34, wherein the gas inlet comprises a gas mixing nozzle for mixing gases as they pass therethrough.

47. The steam generator of claim 46, wherein the gas mixing nozzle comprises a plurality of longitudinal grooves for mixing the gases.

48. The steam generator of claim 34, wherein the gas inlet comprises two separate paths, a hydrogen path and an oxygen path, the hydrogen path and the oxygen path being arranged that the hydrogen and oxygen mix within the pressure vessel as they are output from the gas inlet.

49. The steam generator of claim 34, wherein the pressure vessel incorporates a mixing zone that provides a space within which gases in the vessel are mixed.

50. The steam generator of claim 34, wherein: the pressure vessel comprises a combustion zone within which the ignition means is mounted, the combustion zone being configured to receive hydrogen and oxygen from the gas inlet, and to mix said gases together during the combustion process; the pressure vessel incorporates a mixing zone that provides a space within which gases in the vessel are mixed; and the water outlet is positioned between the combustion zone and the mixing zone.

51. A steam generation system comprising a steam generator, a gas supply system for the generator, a water supply system for the generator, and a controller for the steam generation system, wherein:
the steam generator comprises:
inputs for hydrogen gas, oxygen gas, a purge gas, and water;
an igniter arranged to ignite hydrogen and oxygen within the generator; and
an output for pressurized steam generated by the ignition of hydrogen and oxygen within the generator:
the gas supply system comprises a first, high-pressure stage and a second, low-pressure stage, in which:
the first, high-pressure stage is arranged to receive hydrogen, oxygen and purge gas under pressure and to supply those gases to the second, low-pressure stage under reduced pressure;
the second, low-pressure stage is arranged to receive the gases from the first, high-pressure stage under reduced pressure and to supply those gases to the steam generator:
the water supply system is arranged to supply water under pressure to the steam generator; and
the controller is arranged to control operation of the steam generation system in a Prime phase, a Run phase, and a Shutdown phase, in which:
in the Prime phase, hydrogen gas and oxygen gas are introduced into the first, high-pressure stage and pressure of the hydrogen and oxygen is allowed to build up in the first, high-pressure stage;
in the Run phase, hydrogen gas and oxygen gas are introduced into the second, low-pressure stage at a lower pressure than that prevailing in the first, high-pressure stage; the hydrogen and oxygen gases are then supplied into the steam generator where they are ignited by the igniter; and water is supplied into the steam generator to be mixed with the ignited gases; and
in the Shutdown phase, the supply of hydrogen and oxygen gases to the steam generator is ceased, the supply of water to the steam generator is ceased, and a purge gas is supplied to the gas supply system and the steam generator to purge the gas supply system and the steam generator of hydrogen and oxygen gases.

52. The steam generation system of claim 51, wherein, in the Prime phase, respective low-flow valves are initially opened to allow the pressure of the hydrogen and oxygen to build up gradually; and subsequently, respective high-flow valves are opened to allow the pressure of the hydrogen and oxygen to build up more quickly.

53. The steam generation system of claim 51, wherein, in the Run phase, the controller calculates, from measurements of temperature, pressure and mass flow of hydrogen and oxygen, a stoichiometric mass ratio of oxygen to hydrogen; and controls valves in the system to maintain said stoichiometric mass ratio at a desired level.

54. The steam generation system of claim 53, wherein, in the Run phase, the controller monitors water mass flow and either hydrogen or oxygen mass flow; and adjusts those mass flows to achieve a desired overall mass flow through the steam generator.

55. The steam generation system of claim 51, wherein the controller is operative to detect fault conditions comprising one or more of the following at or within a predetermined time:
pressure within the system falling outside a predetermined limit;
flow rate within the system falling outside a predetermined limit;
temperature within the system falling outside a predetermined limit; and
electrical ignition current supplied to the steam generator falling outside a predetermined limit.

56. The steam generation system of claim 51, wherein the controller is operative to initiate the Shutdown phase upon a fault condition being detected.
